(19) United States
(12) Patent Application Publication
(10) Pub. No.: US 2026/0134018 A1
(43) Pub. Date: May 14, 2026

(54) SECURE GENERATIVE AI ARCHITECTURE

(71) Applicant: MACRONIX INTERNATIONAL CO., LTD., Hsinchu (TW)

(72) Inventors: Yu-Ming HUANG, Zhubei City (TW); Yung-Chun LI, Hsinchu County (TW); Yen-Po LIN, Hsinchu City (TW)

(21) Appl. No.: 18/941,165

(22) Filed: Nov. 8, 2024

(51) Int. Cl. G06F 16/33

(52) U.S. Cl. CPC G06F 16/3344; G06F 16/3347

(57) ABSTRACT

A secure query method for external LLM service is provided. The secure query method comprises receiving an AI query. The secure query method also comprises processing private data stored in a memory of the edge device to obtain a private prompt according to the AI query. The secure query method also comprises transmitting the AI query to a second language generation model. The secure query method also comprises receiving an initial response generated by the second language generation model according to the AI query. The secure query method also comprises inputting the initial response and the private prompt to a first language generation model of the edge device, for obtaining a final response generated by the first language generation model of the edge device.

### TECHNICAL FIELD

The disclosure relates in general to secure query methods for obtaining AI response, and more particularly to edge devices using the same.

### BACKGROUND

The need of application of generative artificial intelligent (GAI) increases explosively in recent years, which the need of GAI is also increases on edging devices or portable devices, such as smart phone. Considering GAI show its remarkable potential for a wide range of applications, for example, ChatGPT of OpenAI is based on Large language model (LLM) to generate original response for all kind of questions, which the computing and memory overhead of such LLM are both quite high, and conventional LLM services is only available on cloud computing, bringing security concern and mandatory internet requirement.

Besides, the conventional LLM has hallucinations, which means LLM may generates factually incorrect or nonsensical response due to limitations in training data, biases in the model, or the inherent complexity of language. Additional data may be use as a prompt for reducing the hallucinations of LLM, which also brings security concern because the additional data may be confidential (private) documents/figures/video must be uploaded to the cloud. Accordingly, there are needs for techniques of secure query for obtaining AI response from LLM service without uploading private data to the cloud while improving the accuracy of AI response.

### SUMMARY

The present disclosure describes techniques of secure query of an edge device including a small language model (SLM) and private data cooperating with a LLM service provided by a cloud server or other external computing system.

The first aspect of the present disclosure features an edge device. The edge device comprises a user interface, configured to receive an AI query. The edge device also comprises a processor coupled to the user interface. The edge device also comprises a memory coupled to the processor and configured to store private data. The edge device also comprises a neural engine coupled to the processor and configured to execute a first language generation model. The edge device also comprises a communication module coupled to the processor. The processor is configured to process the private data to obtain a private prompt according to the AI query, when the AI query is input from the user interface. The processor is also configured to transmit the AI query to a second language generation model of an external server by the communication module. The processor is also configured to receive an initial response generated by the second language generation model by the communication module. The processor is also configured to input the initial response and the private prompt to the first language generate model to obtain a final response. A number of model parameter of the second language generation model is greater than a number of model parameter of the first language generation model.

The second aspect of the present disclosure features a secure query method for external LLM service. The secure query method comprises receiving, by a user interface of an edge device, an AI query. The secure query method also comprises processing, by a processor of the edge device, private data stored in a memory of the edge device to obtain a private prompt according to the AI query. The secure query method also comprises transmitting, by a communication module of the edge device, the AI query to a second language generation model of the external LLM service. The secure query method also comprises receiving, by the communication module, an initial response generated by the second language generation model according to the AI query. The secure query method also comprises inputting the initial response and the private prompt to a first language generation model executed by a neural engine of the edge device, for obtaining a final response generated by the first language generation model of the edge device. A number of model parameter of the first language generation model is greater than a number of model parameter of the second language generation model.

The third aspect of the present disclosure features a secure query method for external LLM service. The secure query method comprises receiving, by a user interface of an edge device, an AI query. The secure query method also comprises processing, by a processor of the edge device, private data stored in a memory of the edge device to obtain a private prompt according to the AI query. The secure query method also comprises determining, by the processor of the edge device, whether the edge device fits a solution requirement of the AI query according to a capability of a first language generation model executed by a neural engine of the edge device. The secure query method also comprises, upon determining that the edge device fits the solution requirement of the AI query, inputting the AI query and the private prompt to the first language generation model for obtaining a final response from the first language generation model of the edge device. The secure query method also comprises, upon determining that the edge device does not fit the solution requirement of the AI query, transmitting, by a communication module of the edge device, the AI query to a second language generation model of the external LLM service. The secure query method also comprises receiving, by the communication module, an initial response generated by the second language generation model of the external LLM service according to the AI query. The secure query method also comprises inputting the initial response and the private prompt to the first language generation model for obtaining the final response from the first language generation model of the edge device, wherein a number of model parameter of the second language generation model is greater than a number of model parameter of the first language generation model.

Embodiments of the above techniques include methods, systems, circuits, computer program products and computer-readable media. In one example, a method can include the above-described actions. In another example, one such computer program product is suitably embodied in a non-transitory machine-readable medium that stores instructions executable by one or more processors. The instructions are configured to cause the one or more processors to perform the above-described actions. One such computer-readable medium stores instructions that, when executed by one or more processors, are configured to cause the one or more processors to perform the above-described action

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram illustrating an example edge device coupled to an external LLM service, according to one or more implementations of the present disclosure.

FIGS. 2A and 2B are block diagrams illustrating the example edge device executing a decision model, and a retrieval augmented generation (RAG) for a private prompt, according to one or more implementations of the present disclosure.

FIG. 3 is a flowchart of an example secure query process for external LLM service, according to one or more implementations of the present disclosure.

FIG. 4 is a flowchart of another example secure query process for external LLM service, according to one or more implementations of the present disclosure.

Like reference numbers and designations in the various drawings indicate like elements. It is also to be understood that the various exemplary implementations shown in the figures are merely illustrative representations and are not necessarily drawn to scale.

### DETAILED DESCRIPTION

Regarding the capability and security of language models, it is contracted for considering both. For example, applying small language model (SLM) solutions in edge device on premise could have indisputable security and lower complexity or power consumption. However, due to the weak capability of reasoning from the SLM, complex AI queries are highly-likely to be misunderstood, which might causes stylistic issues or nonsensical responses from the SLM. For another example, applying LLM services of cloud solutions may have greater capability and better cost efficiency comparing to the SLM solutions in edge device on premise. However, due to security issues, without uploading private data or information for guiding responses of the LLM as prompt, the responses of the LLM may include hallucination issues, or the private data or information need to be uploaded and exposed to the cloud to improving the accuracy of the responses of the LLM.

According to the techniques provided by the present disclosure, if the AI query is determined as a hard request (hard to be solved by the SLM of the edge device), a response of the AI query from the LLM service of the cloud can be implemented as an input of SLM, which can be revised by SLM of the edge device according to the specific knowledge in private or confidential data. As a result, the quality and correctness of the response of LLM service can be improved without exposing private or confidential data to the cloud.

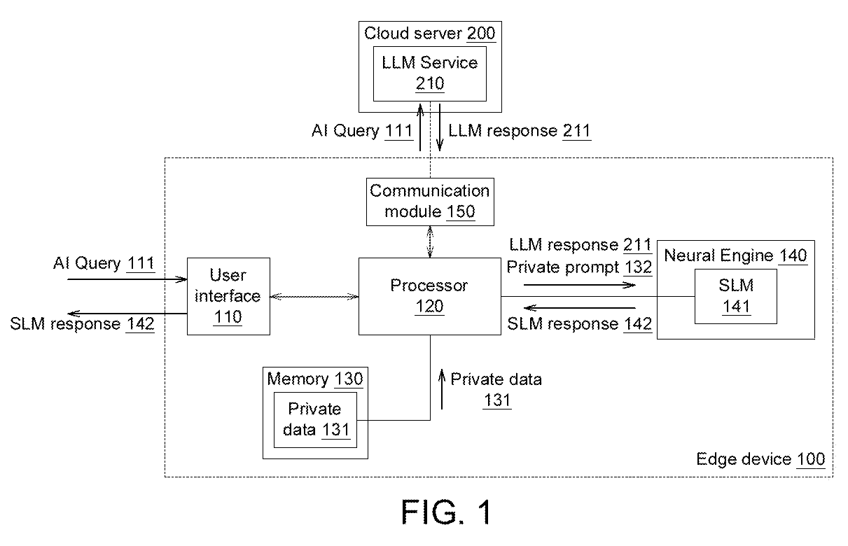

FIG. 1 is a block diagram illustrating an example edge device 100 coupled to an external LLM service 210 of the cloud server 200, according to one or more implementations of the present disclosure. The edge device 100 comprises a user interface 110, a processor 120, a memory 130, a neural engine 140, and a communication module 150. The processor 120 is coupled to the user interface 110, the memory 130, the neural engine 140, and the communication module 150.The processor 120 is a CPU, a GPU, a general-purpose microprocessor, an application-specific microcontroller, or other types of AI accelerators of the edge device 100. The memory 130 is a non-volatile memory that is configured for long-term storage of instructions and/or data, or some other suitable non-volatile memory device or storage device. The edge device 100 is coupled to the cloud server 200 via the communication module 150 with wire or wirelessly, which enables the edge device 100 accessing the LLM service 210 of the cloud server 200 via the internet or intranet. In some implementations, the LLM service 210 of the cloud server 200 can be accessed via a web browser as an interface for inputting data (such as AI query 111) to or obtaining data (such as LLM response 211) from the LLM service 210 of the cloud server 200, which also the LLM service 210 of the cloud server 200 can refer open data via web browser as part of input to improve the response quality of LLM service without uploading any no private data to the cloud server 200. The cloud server 200 herein is merely an example of computing system with high computing capability for operating LLM services. In other case, the edge device 100 also can be coupled to other external computing system operating LLM services for obtaining the LLM response without uploading any private data.

The user interface 110 can receive an AI query 111 from a user and reply a SLM response 142 to the user as a final result of the AI query 111 after computing. To obtain the SLM response 142, once the AI query 111 is input, the processor 120 can process the AI query 111 and access private data 131 stored in the memory 130 for obtaining a private prompt 132 according to the AI query 111. Meanwhile, the AI query 111 is also transmitted to the LLM service 210 of the cloud server 200 by the communication module 150. Then, a LLM response 211 generated by the LLM service 210 according to the AI query 111 is received by the communication module 150, and the processor 120 enables the LLM response 211 and the private prompt 132 to be input to a SLM 141 included in and executed by the neural engine 140, to obtain the SLM response 142 generated by the SLM 141. The private prompt 132 maybe a piece of text or a set of instructions that is provided to the SLM 141 to trigger a specific response or action for improving accuracy of the SLM response 142 corresponding to the AI query 111. In some implementations, the SLM 141 revises the LLM response 211 according to the private prompt 132 to generate the SLM response 142 for improving the accuracy of the AI response. In some implementations, a number of parameters included by the SLM 141 is less than a number of parameters included by a LLM of the LLM service 210, for example, the SLM 141 substantially comprises 3.8 billion parameters, and the LLM of the LLM service 210 comprises 175 billion parameters.

In some implementations, a prompt engineering can be executed by the processor 120, applying to the private data 131 stored in the memory 130 for obtaining the private prompt 132 according to the AI query 111, which the private prompt 132 guides the SLM 141 for revising the LLM response 211 generated by the LLM service 210, for the output (SLM response 142) with more accuracy corresponding to the AI query 111. For example, the private prompt 132 can be programed with natural language from the private data 131 for instructing the SLM 141.

In some implementations, a model fine-tuning can be executed by the processor 120, applying to the private data 131 stored in the memory 130 for obtaining the private prompt 132 according to the AI query 111. The model fine-tuning provide the benefits to leverage the knowledge and representations learned from private data 131, corresponding to the AI query 111. For an example of model fine-tuning, based on the AI query 111 and the private data 131, a matching pre-trained model matches is selected firstly, then the architecture of the pre-trained model can be modified or freeze or unfreeze Layers of the pre-trained model can be determined. After, the modified pre-trained model can be trained based on the AI query 111 and the private data 131 for achieving optimal result, the private prompt 132.

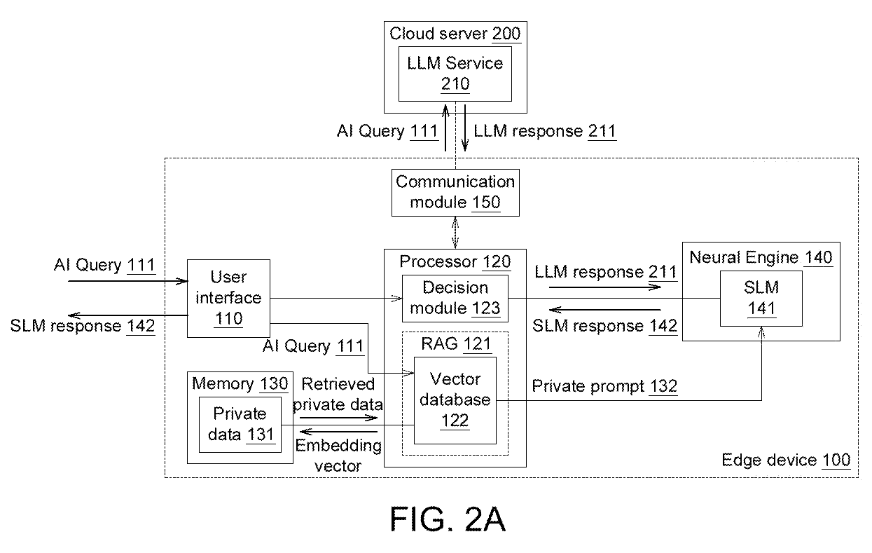

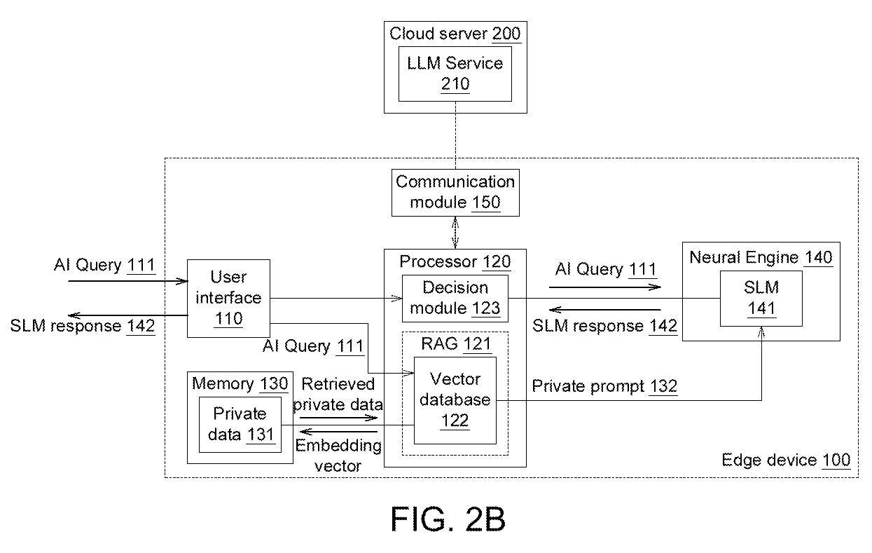

In some implementations, a RAG can be executed by the processor 120, to obtain an embedding vector for retrieving the private data 131 stored in the memory 130 for obtaining the private prompt 132. Examples of edge device executing RAG for private prompt will be detailed described referring to FIGS. 2A and 2B in the following.

FIGS. 2A and 2B are block diagrams illustrating the example edge device 100 executing a decision model 123, and a RAG 121 for private prompt 132, according to one or more implementations of the present disclosure. Differently from the example of FIG. 1, in examples of FIGS. 2A and 2B, the processor 120 of the edge device 100 executes a decision model 123, and a RAG 121 for private prompt 132.

Referring to FIG. 2A, to obtain the SLM response 142, once the AI query 111 is input, the processor 120 processes the AI query 111 and executes a decision model 123 for determining whether the edge device 100 fits a solution requirement of the AI query 111 according to a capability of the SLM 141 of the edge device 100. Specifically, the decision model 123 determines whether the SLM 141 of the edge device 100 is capable for processing the AI query 111 with specified accuracy by itself without the LLM service 210. For example, the decision model 123 can be a small artificial neural network to predict the response quality of the local SLM 141, which if the prediction (score) of response quality is lower than a pre-defined threshold, the AI query 111 will be firstly transmitted to the LLM service 210 of the cloud server 200. In the case of FIG. 2A, the decision model 123 determines that the edge device 100 does not fit the solution requirement of the AI query 111, which the SLM 141 of the edge device 100 is not capable for processing the AI query 111 with specified accuracy by itself, then the AI query 111 is transmitted to the LLM service 210 of the cloud server 200 by the communication module 150. Meanwhile, the RAG 121 is executed by the processor 120, to obtain an embedding vector for retrieving the private data 131 stored in the memory 130 for obtaining the private prompt 132. The embedding vector is generated from a vector database 122 embedded with the AI query 111 and the private data 131. Then, a LLM response 211 generated by the LLM service 210 according to the AI query 111 is received by the communication module 150, and the processor 120 enables the LLM response 211 and the private prompt 132 to be input to a SLM 141, to obtain the SLM response 142 generated by the SLM 141.

Referring to FIG. 2B, in the case of FIG. 2B, the decision model 123 determines that the edge device 100 fits the solution requirement of the AI query 111, which the SLM 141 of the edge device 100 is capable for processing the AI query 111 with specified accuracy by itself, then the AI query 111 is directly input to the SLM 141. Similarly, the RAG 121 is executed by the processor 120, to obtain an embedding vector for retrieving the private data 131 stored in the memory 130 for obtaining the private prompt 132, which the embedding vector is generated from a vector database 122 embedded with the AI query 111 and the private data 131. Then, with the AI query 111, the private prompt 132 is input to the SLM 141 for directly obtaining the SLM response 142 generated by the SLM 141.

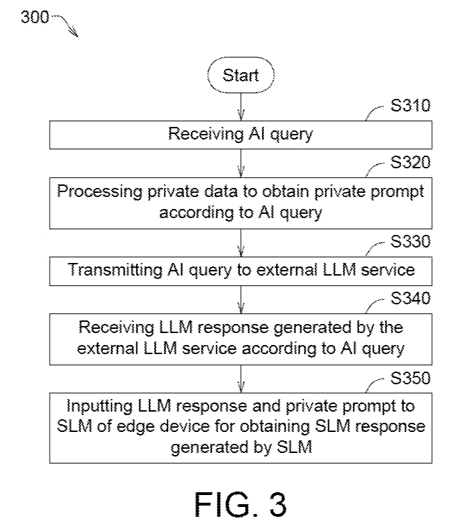

FIG. 3 is a flowchart of an example secure query process 300 for external LLM service, according to one or more implementations of the present disclosure. In step S310, the user interface of the edge device receives an AI query. In step S320, the processor of the edge device processes the private data stored in the memory of the edge device to obtain a private prompt according to the AI query. In step S330, the communication module of the edge device transmits the AI query to the external LLM service. In step S340, the communication module of the edge device receives a LLM response generated by the external LLM service according to the AI query. In step S350, the LLM response and the private prompt are input to the SLM executed by the neural engine of the edge device, for obtaining a SLM response generated by the SLM of the edge device.

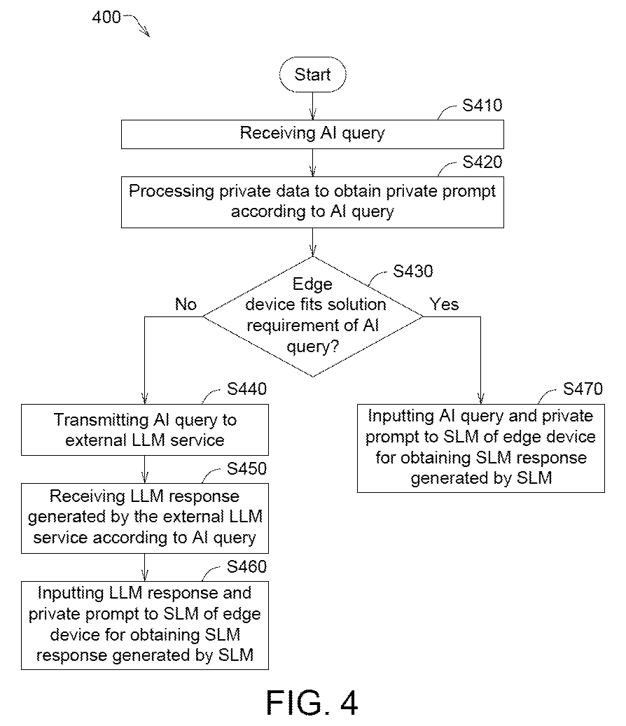

FIG. 4 is a flowchart of another example secure query process 400 for external LLM service, according to one or more implementations of the present disclosure. In step S410, the user interface of the edge device receives an AI query. In step S420, the processor of the edge device processes the private data stored in the memory of the edge device to obtain a private prompt according to the AI query. In step S430, the processor of the edge device determines whether the edge device fits a solution requirement of the AI query according to a capability of the SLM executed by the neural engine of the edge device. Upon determining that the edge device fits the solution requirement of the AI query, in step S470, the AI query and the private prompt are input to the SLM of the edge device for obtaining a SLM response generated by the SLM. Upon determining that the edge device does not fit the solution requirement of the AI query, in step S440, the communication module of the edge device transmits the AI query to the external LLM service. In step S450, the communication module of the edge device receives a LLM response generated by the external LLM service according to the AI query. In step S460, the LLM response and the private prompt are input to the SLM executed by the neural engine of the edge device, for obtaining a SLM response generated by the SLM of the edge device.

In certain configurations, obtaining the second SLM response generated by the SLM, comprises revising the LLM response according to the private prompt to generate the SLM response.

In certain configurations, the processor executes a prompt engineering applying to the private data stored in the memory for obtaining the private prompt according to the AI query.

In certain configurations, the processor executes a model fine-tuning applying to the private data stored in the memory for obtaining the private prompt.

In certain configurations, the processor executes a RAG to obtain an embedding vector for retrieving the private data stored in the memory for obtaining the private prompt. The embedding vector is generated from a vector database embedded with the AI query and the private data.

In certain configurations, a number of parameters included by the SLM is less than a number of parameters included by a LLM of the external LLM service. The LLM substantially comprises 175 billion parameters, and the SLM comprises 3.8 billion parameters.

Accordingly, the techniques according to implementations of the present disclosure provide combination of local SLM in edge device and global LLM in cloud server, which leverages the powerful LLM reasoning capability and rich general knowledge in the cloud without exposing private information. Specifically, it sends a query without private information to the LLM in the cloud, then using the local SLM (with RAG, prompt engineering or model fine-tuning) to revise/correct/supplement the response of LLM according the local private information, which uses the more powerful LLM in the cloud to understand a more sophisticated rule or phenomenon regarding to the AI query, then using the local SLM finish the remaining job with private data or information for obtaining more accurate response.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. An edge device, comprising:
a user interface, configured to receive an AI query;
a processor, coupled to the user interface;
a memory, coupled to the processor and configured to store private data;
a neural engine, coupled to the processor and configured to execute a first language generation model; and
a communication module, coupled to the processor,
wherein the processor is configured to:
upon determining that the AI query is input from the user interface, processes the private data to obtain a private prompt according to the AI query,
transmit the AI query to a second language generation model of an external server by the communication module,
receive an initial response generated by the second language generation model by the communication module, and
input the initial response and the private prompt to the first language generate model to obtain a final response, wherein a number of model parameter of the second language generation model is greater than a number of model parameter of the first language generation model.

2. The edge device of claim 1, wherein the processor executes a decision model configured to determine whether the edge device fits a solution requirement of the AI query according to a capability of the first language generation model executed by the neural engine of the edge device.

3. The edge device of claim 1, wherein the first language generation model revises the initial response according to the private prompt to generate the final response.

4. The edge device of claim 1, wherein the processor is configured to execute a prompt engineering applying to the private data stored in the memory for obtaining the private prompt according to the AI query.

5. The edge device of claim 1, wherein the processor is configured to execute a model fine-tuning applying to the private data stored in the memory for obtaining the private prompt according to the AI query.

6. The edge device of claim 1, wherein the processor is configured to execute a retrieval augmented generation, RAG, to obtain an embedding vector for retrieving the private data stored in the memory for obtaining the private prompt,
wherein the embedding vector is generated from a vector database embedded with the AI query and the private data.

7. A secure query method for external LLM service, comprising:
receiving, by a user interface of an edge device, an AI query;
processing, by a processor of the edge device, private data stored in a memory of the edge device to obtain a private prompt according to the AI query;
transmitting, by a communication module of the edge device, the AI query to a second language generation model of the external LLM service;
receiving, by the communication module, an initial response generated by the second language generation model according to the AI query; and
inputting the initial response and the private prompt to a first language generation model executed by a neural engine of the edge device, for obtaining a final response generated by the first language generation model of the edge device, wherein a number of model parameter of the first language generation model is greater than a number of model parameter of the second language generation model.

8. The secure query method of claim 7, wherein obtaining the final response generated by the first language generation model, comprises revising the initial response according to the private prompt to generate the final response.

9. The secure query method of claim 7, wherein processing the private data stored in the memory of the edge device to obtain the private prompt, comprises executing, by the processor, a prompt engineering applying to the private data stored in the memory for obtaining the private prompt according to the AI query.

10. The secure query method of claim 7, wherein processing the private data stored in the memory of the edge device to obtain the private prompt, comprises executing, by the processor, a model fine-tuning applying to the private data stored in the memory for obtaining the private prompt according to the AI query.

11. The secure query method of claim 7, wherein processing the private data stored in the memory of the edge device to obtain the private prompt, comprises executing, by the processor, a RAG to obtain an embedding vector for retrieving the private data stored in the memory for obtaining the private prompt,
wherein the embedding vector is generated from a vector database embedded with the AI query and the private data.

12. A secure query method for external LLM service, comprising:
receiving, by a user interface of an edge device, an AI query;
processing, by a processor of the edge device, private data stored in a memory of the edge device to obtain a private prompt according to the AI query;
determining, by the processor of the edge device , whether the edge device fits a solution requirement of the AI query according to a capability of a first language generation model executed by a neural engine of the edge device;
upon determining that the edge device fits the solution requirement of the AI query, inputting the AI query and the private prompt to the first language generation model for obtaining a final response from the first language generation model of the edge device; and
upon determining that the edge device does not fit the solution requirement of the AI query, transmitting, by a communication module of the edge device, the AI query to a second language generation model of the external LLM service;
receiving, by the communication module, an initial response generated by the second language generation model of the external LLM service according to the AI query; and
inputting the initial response and the private prompt to the first language generation model for obtaining the final response from the first language generation model of the edge device, wherein a number of model parameter of the second language generation model is greater than a number of model parameter of the first language generation model.

13. The secure query method of claim 12, wherein obtaining the final response from the first language generation model, comprises revising the initial response according to the private prompt to generate the final response.

14. The secure query method of claim 12, wherein processing the private data stored in the memory of the edge device to obtain the private prompt, comprises executing, by the processor, a prompt engineering applying to the private data stored in the memory for obtaining the private prompt according to the AI query.

15. The secure query method of claim 12, wherein processing the private data stored in the memory of the edge device to obtain the private prompt, comprises executing, by the processor, a model fine-tuning applying to the private data stored in the memory for obtaining the private prompt.

16. The secure query method of claim 12, wherein processing the private data stored in a memory of the edge device to obtain the private prompt, comprises executing, by the processor, a RAG to obtain an embedding vector for retrieving the private data stored in the memory for obtaining the private prompt,
wherein the embedding vector is generated from a vector database embedded with the AI query and the private data.
